(19) United States
(12) Patent Application Publication
(10) Pub. No.: US 2025/0365766 A1
(43) Pub. Date: Nov. 27, 2025

(54) TXOP FOR PEER-TO-PEER COMMUNICATION

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Plano, TX (US); Bilal Sadiq, Plano, TX (US)

(21) Appl. No.: 19/182,510

(22) Filed: Apr. 17, 2025

Related U.S. Application Data
(60) Provisional application No. 63/651,595, filed on May 24, 2024.

(51) Int. Cl. H04W 74/0816; H04W 48/16; H04W 76/14

(52) U.S. Cl. CPC H04W 74/0816; H04W 48/16; H04W 76/14

(57) ABSTRACT

Methods and apparatuses for TXOP for P2P communication. A method performed by a STA includes indicating, to a second STA, that the first STA has a coexistence constraint; and transmitting, to the second STA, a message that includes information pertaining to the coexistence constraint.

### CROSS-REFERENCE TO RELATED APPLICATION(S) AND CLAIM OF PRIORITY

This application claims priority under 35 U.S.C. § 119(e) to U.S. Provisional Patent Application No. 63/651,595, filed on May 24, 2024, which is hereby incorporated by reference in its entirety.

### TECHNICAL FIELD

This disclosure relates generally to wireless communication, and more specifically to transmit opportunity (TXOP) for peer-to-peer (P2P) communication.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.1 Jax, etc.

### SUMMARY

Embodiments of the present disclosure provide methods and apparatuses for TXOP for P2P communication.

In one embodiment, a method of wireless communication performed by a first station (STA) associated with an access point (AP) comprises: indicating, to a second STA, that the first STA has a coexistence constraint; and transmitting, to the second STA, a message that includes information pertaining to the coexistence constraint.

In another embodiment, an AP comprises: a processor; and a transceiver operably coupled with the processor. The transceiver configured to: receive a message from a first station (STA) associated with the AP, the message indicating that the first STA has a coexistence constraint with a second STA and requesting a transmit opportunity (TXOP) from the AP for allocating the TXOP to the first STA.

In yet another embodiment, a first STA comprises: a transceiver; and a processor operably coupled with the transceiver. The processor is configured to: indicate, to a second STA, that the first STA has a coexistence constraint. The transceiver is configured to transmit, to the second STA, a message that includes information pertaining to the coexistence constraint.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of a network where infrastructure traffic and non-infrastructure traffic coexist according to embodiments of the present disclosure;

FIG. 5 illustrates an example of a transmission opportunity (TXOP) request for handling P2P communication under coexistence constraints according to embodiments of the present disclosure;

FIG. 6 illustrates an example of frame exchanges for a TXOP request process for handling coexistence constraints according to embodiments of the present disclosure;

FIG. 7 illustrates an example of a process performed by a STA for a TXOP request for handling coexistence constraints according to embodiments of the present disclosure;

FIG. 8 illustrates an example of a process performed by an AP for a TXOP request for handling coexistence constraints according to embodiments of the present disclosure; and

FIG. 9 illustrates an example method performed by a STA according to embodiments of the present disclosure.

### DETAILED DESCRIPTION

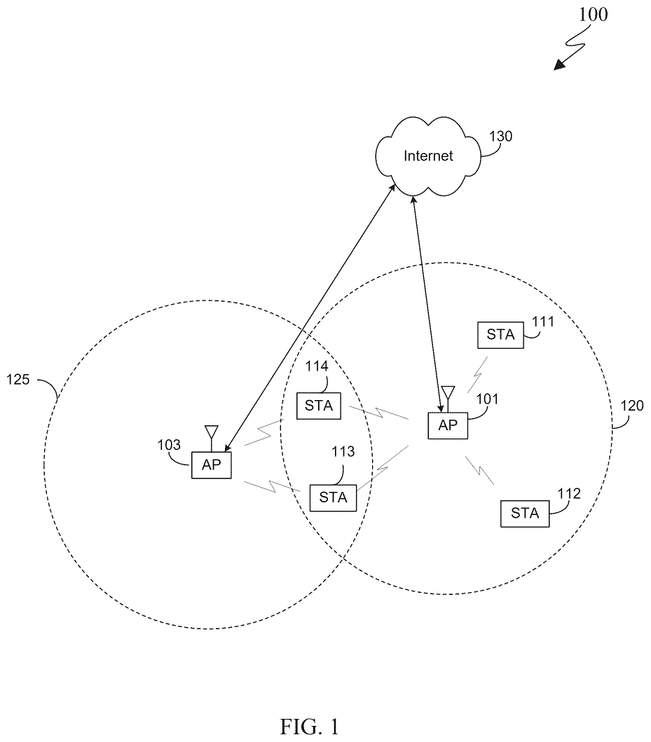

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP”, such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating TXOP for P2P communication. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

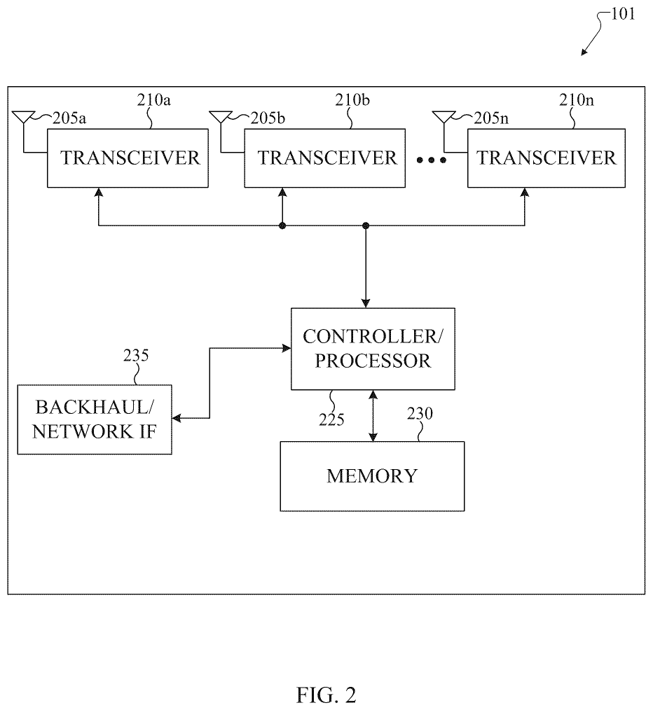

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating TXOP for P2P communication. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating TXOP for P2P communication. Although FIG. 2 illustrates one example of AP 101, various changes may be made to FIG. 2. For example, the AP 101 could include any number of each component shown in FIG. 2. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2 could be combined, further subdivided, or omitted and additional components could be added according to particular needs.

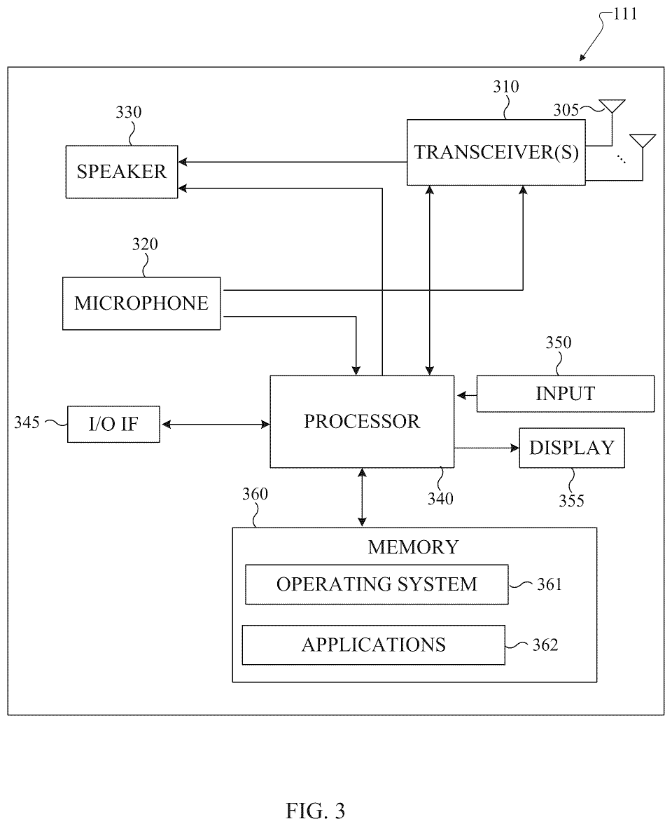

FIG. 3 illustrates an example STA 111 according to various embodiments of the present disclosure. The embodiment of the STA 111 illustrated in FIG. 3 is for illustration only, and the STAs 111-115 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate TXOP for P2P communication. In some embodiments, the processor 340 includes at least one microprocessor or microcontroller.

The processor 340 is also capable of executing other processes and programs resident in the memory 360, such as operations for facilitating TXOP for P2P communication. The processor 340 can move data into or out of the memory 360 as required by an executing process. In some embodiments, the processor 340 is configured to execute a plurality of applications 362, such as applications for facilitating TXOP for P2P communication. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that a next generation WLAN system needs to provide better support for low-latency applications. Today it is not uncommon to observe numerous devices operating on the same network. Many of such devices may be latency-tolerant but still contend with the devices with low-latency applications for the same time and frequency resources. In some cases, the access point (AP) as the network controller may not have enough control over the unregulated/unmanaged traffic that contend with the low-latency traffic within the infrastructure BSS. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or P2P networks. The next generation WLAN system needs mechanisms to better handle the unmanaged traffic in order to prioritize the low-latency traffic in the network.

Embodiments of the present disclosure recognize that a first STA may have a coexistence (coex) event. The first STA may have a P2P link with a second STA. Due to the coex event, the first STA may not be able to communicate with the second STA during the coex event. However, currently, there is no mechanism to efficiently inform the second STA about the unavailability of the first STA due to the coex event of the first STA.

Accordingly, embodiments of the present disclosure can provide methods and apparatuses for a framework to request for TXOP from the AP so that a first STA can inform a second STA about the unavailability of the first STA due to a coex event of the first STA.

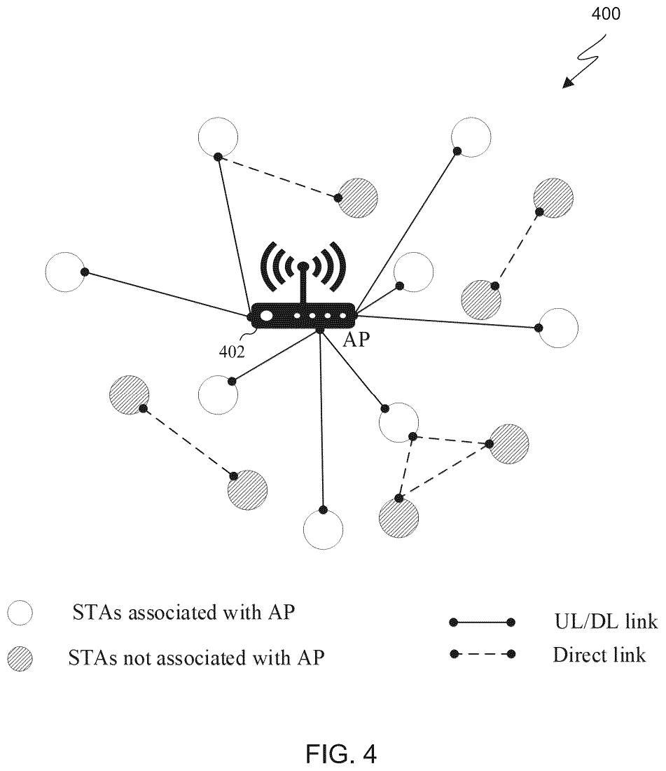

FIG. 4 illustrates an example of a network 400 where infrastructure traffic and non-infrastructure traffic coexist according to embodiments of the present disclosure. For example, the network 400 can be implemented in network 100 of FIG. 1. The embodiment of the example network 400 where infrastructure traffic and non-infrastructure traffic coexist shown in FIG. 4 is for illustration only. Other embodiments of the example network 400 where infrastructure traffic and non-infrastructure traffic coexist could be used without departing from the scope of this disclosure.

As illustrated in FIG. 4, the AP 402 as the network controller may not have enough control over the unregulated/unmanaged traffic that contend with the low-latency traffic within the infrastructure BSS. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or P2P networks. FIG. 4 illustrates this kind of network.

According to some embodiments, a first STA can indicate to a second STA that the first STA has coexistence constraints. Along with the indication of coexistence constraints, the first STA can also send messages to the second STA containing information pertaining to the coexistence. According to some embodiments, the first STA can be a non-AP STA. According to some embodiments, the first STA can be an AP. According to some embodiments, the second STA can be a non-AP STA. According to some embodiments, the second STA can be an AP.

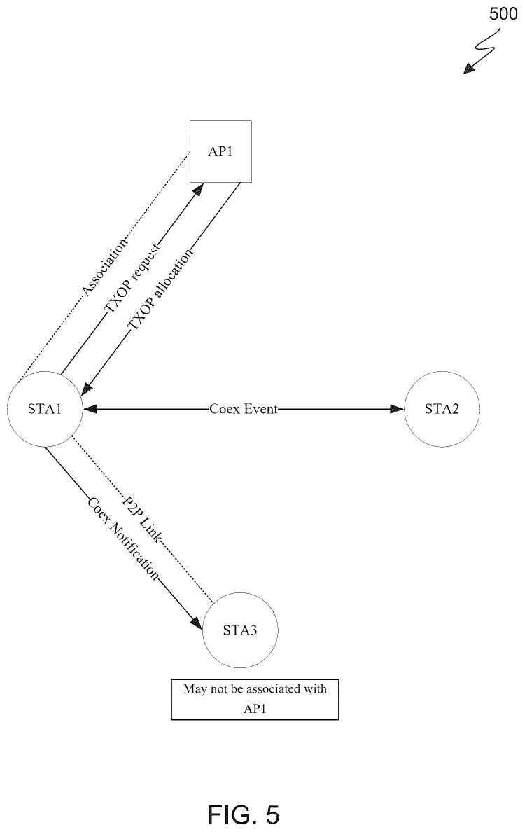

FIG. 5 illustrates an example of a TXOP request for handling P2P communication under coexistence constraints 500 according to embodiments of the present disclosure. For example, the TXOP request for handling P2P communication under coexistence constraints 500 can be implemented by STAs 111-112 and AP 101 of FIG. 1. The embodiment of the example of a TXOP request for handling P2P communication under coexistence constraints 500 shown in FIG. 5 is for illustration only. Other embodiments of the example of a TXOP request for handling P2P communication under coexistence constraints 500 could be used without departing from the scope of this disclosure.

According to some embodiments, for the scenario where a first STA has an upcoming coexistence (coex) event with a second STA, if the first STA also has a peer-to-peer (P2P) link established with a third STA, then the first STA can inform a fourth STA or inform its associated AP about information related to this coexistence event along with the information on the P2P link. According to one embodiment, in this scenario, the first STA can also send a message to the fourth STA or to its associated AP, where the message would indicate a request for a TXOP from the fourth STA or from the associated AP. If the request for TXOP is granted, then the first STA can use the received TXOP to manage the P2P links to avoid any coexistence issues. For example, the first STA can use the received TXOP to transmit to the third STA, informing the third STA about the upcoming coexistence event of the first STA. According to some other embodiment, the first STA can inform both the third STA and the fourth STA or the associated AP about the coexistence constraint of the first STA. When the first STA informs the third STA or the fourth STA about the coexistence event of the first STA, the first STA can also include some identifier of the second STA, with which the first STA has the coexistence event.

In one example, upon receiving the TXOP, the first STA can use the TXOP to send a message to the P2P STA (the third STA) to indicate to the P2P STA (the third STA) that the first STA is going on power save mode or sleep mode. According to some embodiments, upon receiving the TXOP, the first STA can use the TXOP to send a message to the P2P STA (the third STA) to indicate to the P2P STA (the third STA) that the first STA is unavailable during a time period due to the coex issue. In this regard, in one example, the first STA can indicate an unavailability start time, an unavailability end time, an unavailability period, an unavailability periodicity, an unavailability interval, or any other parameters related to the unavailability of the first STA due to its coex event. According to some embodiments, upon receiving the message from the first STA, the third STA (the STA that has the P2P link with the first STA) can avoid transmitting any frames to the first STA during the time indicated by the first STA during which the first STA will be unavailable (due to the coex event of the first STA). According to some embodiments, upon receiving the message from the first STA, the third STA (the STA that has the P2P link with the first STA) can avoid soliciting any frames from the first STA during the time indicated by the first STA during which the first STA will be unavailable (due to the coex event of the first STA). This is illustrated in FIG. 5.

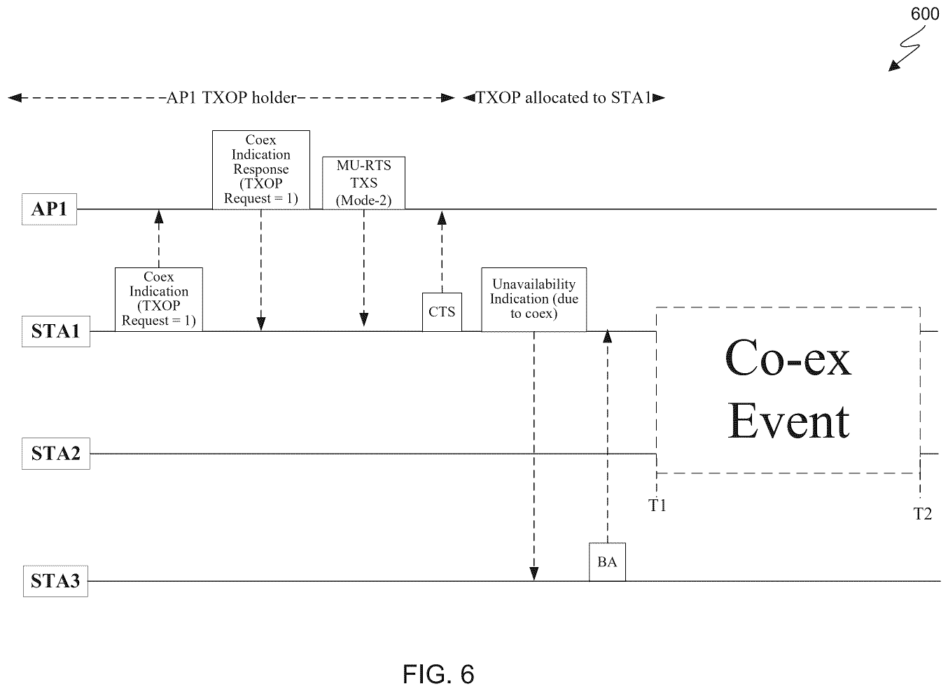

FIG. 6 illustrates an example of frame exchanges for a TXOP request process for handling coexistence constraints 600 according to embodiments of the present disclosure. For example, the TXOP request process for handling coexistence constraints 600 can be implemented by STAs 111-113 and AP 101 of FIG. 1. The embodiment of the example of frame exchanges for a TXOP request process for handling coexistence constraints 600 shown in FIG. 6 is for illustration only. Other embodiments of the example of frame exchanges for a TXOP request process for handling coexistence constraints 600 could be used without departing from the scope of this disclosure.

In some embodiments as illustrated in FIG. 6, STA1 may have a coex event with STA2 where the coex event may start from time T1 and may continue until time T2; STA1 may be associated with AP1; and STA1 may have a P2P link with STA3, which may not be associated with AP1. Before time T1, STA1 may need to inform STA3 that STA1 will be unavailable from time T1 to time T2. In order to get the opportunity to send a message to STA3 informing STA3 about the coex event, STA1 can send a message to the AP, where the message may contain a request for TXOP allocation to STA1. Upon receiving the request from STA1, the AP allocates a TXOP to STA1. Upon receiving the TXOP from the AP, STA1 may use the TXOP to indicate to STA3 that STA1 will be unavailable from time T1 to time T2.

According to some embodiments, in reference to the previous embodiments described herein, the first STA (STA1) can send a Coex Indication element or a Coex Indication frame to the AP to inform the AP about the coex constraints for STA1. The Coex Indication element may contain, along with other coex related parameters, an indication of whether the first STA also requests for TXOP for informing its peer STAs about the upcoming coex event. For example, there can be a TXOP Request field in the Coex Indication element. If the TXOP Request field is set to 1, that may indicate that the first STA requests for TXOP to handle the coex event with its peer STA.

According to some embodiments, upon receiving the Coex Indication element/frame from the first STA where the TXOP Request field in the Coex Indication element/frame is set to 1, the AP can send an Ack or Block Ack (BA) frame to the first STA. This may mean that the AP agrees to send a TXOP to STA1 for handling STA1's coex event. According to other embodiments, upon receiving the Coex Indication element from the first STA where the TXOP Request field in the Coex Indication frame is set to 1, the AP can send a Coex Indication Response element/frame to the first STA where the Coex Indication Response may indicate whether the AP accepts or rejects the request for TXOP. For example, in this response frame, a TXOP Request field can be present-if this field is set to 1, that may indicate that the AP accepts the request to allocate TXOP to the first STA so that the first STA can handle its coex; otherwise, the AP rejects the request.

According to some embodiments, in reference to the previous embodiments described herein, if the AP accepts the request for allocating TXOP to the first STA, the AP can send an MU-RTS TXS trigger frame to the first STA. The MU-RTS TXS trigger frame can be of Mode-2 type. The MU-RTS TXS trigger frame can indicate the TXOP allocation for P2P communication. Other forms of trigger frames may also be used for this purpose. Upon receiving the MU-RTS TXS trigger frame, the first STA can send a clear to send (CTS) frame.

According to some embodiments, upon receiving the trigger frame, the first STA can use the TXOP to indicate to the third STA that the first STA would be unavailable from time T1 to time T2. For this purpose, the first STA can send an Unavailability Indication message (element or frame) to the third STA, where this unavailability indication may contain information related to coex constraints for STA, such as:
Start time of the unavailability
End time of unavailability
Power saving mode upon the end of the unavailability
Nature of the coex event, e.g. Bluetooth, Ultra-Wideband (UWB), etc.
Periodicity of the unavailability
Interval or unavailability
Duration of the unavailability
Etc.
   The above embodiments are illustrated in FIG. 6.

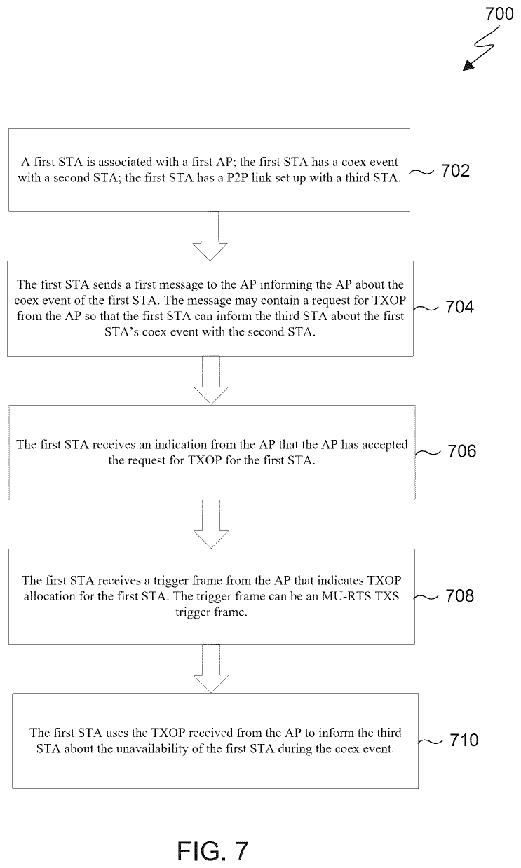

FIG. 7 illustrates an example of a process 700 performed by a STA for a TXOP request for handling coexistence constraints to embodiments of the present disclosure. For example, the example of the process 700 performed by a STA for a TXOP request for handling coexistence constraints can be implemented by any of STAs 111-114 and AP 101 of FIG. 1. The embodiment of the example process 700 performed by a STA for a TXOP request for handling coexistence constraints shown in FIG. 7 is for illustration only. Other embodiments of the example process 700 performed by a STA for a TXOP request for handling coexistence constraints could be used without departing from the scope of this disclosure.

As illustrated in FIG. 7, the process 700 begins at step 702, where a first STA is associated with a first AP; the first STA has a coex event with a second STA; and the first STA has a P2P link set up with a third STA. At step 704, the first STA sends a first message to the AP informing the AP about the coex event of the first STA. The message may contain a request for TXOP from the AP so that the first STA can inform the third STA about the first STA's coex event with the second STA. For example, the first STA can send a coex indication element or a coex indication frame to the AP to inform the AP about the coex constraints for STA1. At step 706, the first STA receives an indication from the AP that the AP has accepted the request for TXOP for the first STA. For example, the first STA can receive a coex indication response element or a coex indication response frame from the AP to inform the first STA that the AP has accepted the request for TXOP for the first STA. At step 708, the first STA receives a trigger frame from the AP that indicates TXOP allocation for the first STA. The trigger frame can be an MU-RTS TXS trigger frame. Other forms of trigger frames may also be used. At step 710, the first STA uses the TXOP received from the AP to inform the third STA about the unavailability of the first STA during the coex event.

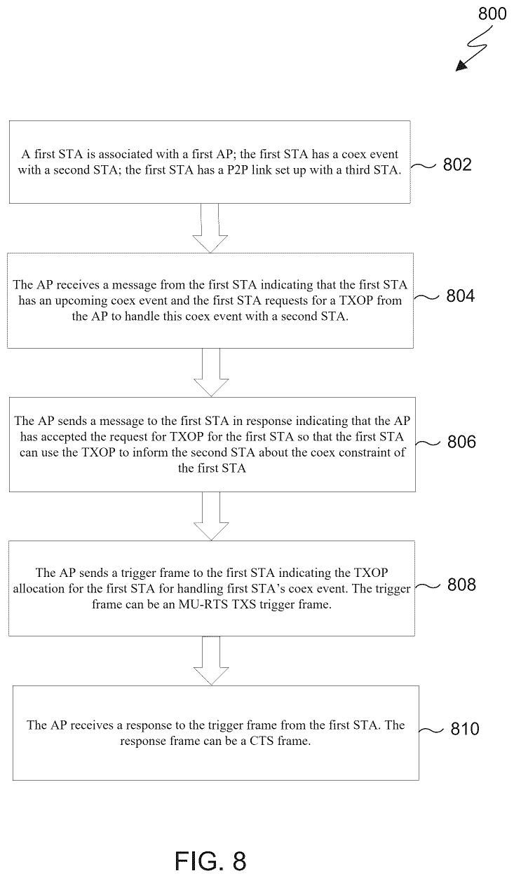

FIG. 8 illustrates an example of a process 800 performed by an AP for a TXOP request for handling coexistence constraints according to embodiments of the present disclosure. For example, the example of the process 800 performed by an AP for a TXOP request for handling coexistence constraints can be implemented by any of STAs 111-114 and AP 101 of FIG. 1. The embodiment of the example process 800 performed by an AP for a TXOP request for handling coexistence constraints shown in FIG. 8 is for illustration only. Other embodiments of the example process 800 performed by an AP for a TXOP request for handling coexistence constraints could be used without departing from the scope of this disclosure.

As illustrated in FIG. 8, the process 800 begins at step 802, where a first STA is associated with a first AP; the first STA has a coex event with a second STA; and the first STA has a P2P link set up with a third STA. At step 804, the AP receives a message from the first STA indicating that the first STA has an upcoming coex event and the first STA requests for a TXOP from the AP to handle this coex event with a second STA. For example, the AP can receive first a coex indication element or a coex indication frame from the first STA to inform the AP about the coex constraints for STA1. At step 806, the AP sends a message to the first STA in response to the first STA's request indicating that the AP has accepted the request for TXOP for the first STA so that the first STA can use the TXOP to inform the second STA about the coex constraint of the first STA. For example, the AP can send a coex indication response element or a coex indication response frame to the first STA to inform the first STA that the AP has accepted the request for TXOP for the first STA. At step 808, the AP sends a trigger frame to the first STA indicating the TXOP allocation for the first STA for handling the first STA's coex event. The trigger frame can be an MU-RTS TXS trigger frame. Other forms of trigger frames may also be used. At step 810, the AP receives a response to the trigger frame from the first STA. The response frame can be a CTS frame.

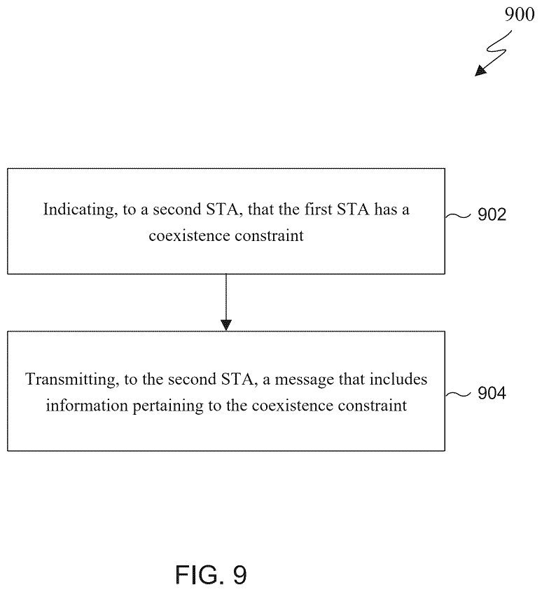

FIG. 9 illustrates an example method 900 performed by STA in a wireless communication system according to embodiments of the present disclosure. For example, the method 900 of FIG. 9 can be performed by any of the STAs 111-114 of FIG. 1, such as the STA 111 of FIG. 3, and a corresponding method can be performed by any of the APs 101-103 of FIG. 1, such as AP 101 of FIG. 2. The method 900 is for illustration only and other embodiments can be used without departing from the scope of the present disclosure.

As illustrated in FIG. 9, the method 900 begins at step 902, where the first STA indicates, to a second STA, that the first STA has a coexistence constraint. At step 904, the first STA transmits, to the second STA, a message that includes information pertaining to the coexistence constraint.

In some embodiments, the first STA forms a P2P link with a third STA; informs a fourth STA or an AP associated with the first STA about the information pertaining to the coexistence constraint; and informs the third STA about the information pertaining to the coexistence constraint via the P2P link with the third STA.

In some embodiments, the first STA transmits a message to the fourth STA or to the AP requesting a TXOP from the fourth STA or the AP; receives the TXOP from the fourth STA or the AP; and uses the received TXOP to manage P2P links to avoid the coexistence constraint or to transmit over the P2P links.

In some embodiments, the first STA transmits a message to the third STA indicating that the first STA is unavailable during a time period due to the coexistence constraint, where the message that indicates that the first STA is unavailable during the time period includes one or more of: an unavailability start time; an unavailability end time; an unavailability period; an unavailability periodicity; and an unavailability interval.

In some embodiments, the first STA transmits a message to an AP associated with the first STA to inform the AP about the coexistence constraint, the message including a request for a TXOP from the AP for allocating the TXOP to the first STA; and receives a response message from the AP that indicates whether the AP accepts or rejects the request for the TXOP.

In some embodiments, the response message from the AP indicates acceptance of the request for the TXOP, and the first STA: receives the TXOP; and receives a trigger frame from the AP to allocate the TXOP. The trigger frame is: a form of multiuser request-to-send (MU-RTS) trigger frame; or a form of MU-RTS transmit opportunity sharing (TXS) trigger frame.

In some embodiments, the first STA transmits a message to a third STA indicating that the first STA is unavailable during a time period due to the coexistence constraint, where the message that indicates that the first STA is unavailable during the time period includes one or more of: a start time of unavailability; an end time of unavailability; a power saving mode upon an end of unavailability; a nature of the coexistence constraint; a periodicity of the unavailability; an interval of the unavailability; and a duration of the unavailability.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a first station (STA), the method comprising:
indicating, to a second STA, that the first STA has a coexistence constraint; and
transmitting, to the second STA, a message that includes information pertaining to the coexistence constraint.

2. The method of claim 1, further comprising:
forming a peer-to-peer (P2P) link with a third STA;
informing a fourth STA or an access point (AP) associated with the first STA about the information pertaining to the coexistence constraint; and
informing the third STA about the information pertaining to the coexistence constraint via the P2P link with the third STA.

3. The method of claim 2, further comprising:
transmitting a message to the fourth STA or to the AP requesting a transmit opportunity (TXOP) from the fourth STA or the AP;
receiving the TXOP from the fourth STA or the AP; and
using the received TXOP to manage P2P links to avoid the coexistence constraint or to transmit over the P2P links.

4. The method of claim 3, wherein using the received TXOP comprises:
transmitting a message to the third STA indicating that the first STA is unavailable during a time period due to the coexistence constraint, wherein the message that indicates that the first STA is unavailable during the time period includes one or more of:
an unavailability start time;
an unavailability end time;
an unavailability period;
an unavailability periodicity; and
an unavailability interval.

5. The method of claim 1, further comprising:
transmitting a message to an access point (AP) associated with the first STA to inform the AP about the coexistence constraint, the message including a request for a transmit opportunity (TXOP) from the AP for allocating the TXOP to the first STA; and
receiving a response message from the AP that indicates whether the AP accepts or rejects the request for the TXOP.

6. The method of claim 5, wherein:
the response message from the AP indicates acceptance of the request for the TXOP;
the method further comprises:
receiving the TXOP; and
receiving a trigger frame from the AP to allocate the TXOP; and
the trigger frame is:
a form of multiuser request-to-send (MU-RTS) trigger frame; or
a form of MU-RTS transmit opportunity sharing (TXS) trigger frame.

7. The method of claim 6, further comprising:
transmitting a message to a third STA indicating that the first STA is unavailable during a time period due to the coexistence constraint, wherein the message that indicates that the first STA is unavailable during the time period includes one or more of:
a start time of unavailability;
an end time of unavailability;
a power saving mode upon an end of unavailability;
a nature of the coexistence constraint;
a periodicity of the unavailability;
an interval of the unavailability; and
a duration of the unavailability.

8. An access point (AP), comprising:
a processor; and
a transceiver operably coupled with the processor, the transceiver configured to:
receive a message from a first station (STA) associated with the AP, the message indicating that the first STA has a coexistence constraint with a second STA and requesting a transmit opportunity (TXOP) from the AP for allocating the TXOP to the first STA.

9. The AP of claim 8, wherein the transceiver is further configured to transmit a response message to the first STA that indicates whether the AP accepts or rejects the request for the TXOP.

10. The AP of claim 9, wherein:
the response message from the AP indicates acceptance of the request for the TXOP; and
the transceiver is configured to:
transmit the TXOP to the first STA; and
transmit a trigger frame to the first STA to allocate the TXOP.

11. The AP of claim 10, wherein the trigger frame is a form of multiuser request-to-send (MU-RTS) trigger frame.

12. The AP of claim 10, wherein the trigger frame is a form of multiuser request-to-send transmit opportunity sharing (MU-RTS TXS) trigger frame.

13. The AP of claim 10, wherein the transceiver is further configured to receive a response to the trigger frame from the first STA, the response comprising a clear to send (CTS) message.

14. A first station (STA), comprising:
a transceiver; and
a processor operably coupled with the transceiver, the processor configured to indicate, to a second STA, that the first STA has a coexistence constraint,
wherein the transceiver is configured to transmit, to the second STA, a message that includes information pertaining to the coexistence constraint.

15. The first STA of claim 14, wherein the processor is further configured to:
form a peer-to-peer (P2P) link with a third STA;
inform a fourth STA or an access point (AP) associated with the first STA about the information pertaining to the coexistence constraint; and
inform the third STA about the information pertaining to the coexistence constraint via the P2P link with the third STA.

16. The first STA of claim 15, wherein:
the transceiver is configured to:
transmit a message to the fourth STA or to the AP requesting a transmit opportunity (TXOP) from the fourth STA or the AP; and
receive the TXOP from the fourth STA or the AP; and
the processor is configured to use the received TXOP to manage P2P links to avoid the coexistence constraint or to transmit over the P2P links.

17. The first STA of claim 16, wherein:
the transceiver is configured to transmit the message to the third STA indicating that the first STA is unavailable during a time period due to the coexistence constraint, and
the message that indicates that the first STA is unavailable during the time period includes one or more of:
an unavailability start time;
an unavailability end time;
an unavailability period;
an unavailability periodicity; and
an unavailability interval.

18. The first STA of claim 14, wherein the transceiver is further configured to:
transmit a message to an access point (AP) associated with the first STA to inform the AP about the coexistence constraint, the message including a request for a transmit opportunity (TXOP) from the AP for allocating the TXOP to the first STA; and
receive a response message from the AP that indicates whether the AP accepts or rejects the request for the TXOP.

19. The first STA of claim 18, wherein:
the response message from the AP indicates acceptance of the request for the TXOP; and
the transceiver is further configured to:
receive the TXOP; and
receive a trigger frame from the AP to allocate the TXOP; and
the trigger frame is:
a form of multiuser request-to-send (MU-RTS) trigger frame; or
a form of MU-RTS transmit opportunity sharing (TXS) trigger frame.

20. The first STA of claim 19, wherein:
the transceiver is further configured to transmit a message to a third STA indicating that the first STA is unavailable during a time period due to the coexistence constraint, wherein the message that indicates that the first STA is unavailable during the time period includes one or more of:
a start time of unavailability;
an end time of unavailability;
a power saving mode upon an end of unavailability;
a nature of the coexistence constraint;
a periodicity of the unavailability;
an interval of the unavailability; and
a duration of the unavailability.
